(19) United States
(12) Patent Application Publication
(10) Pub. No.: US 2023/0306202 A1
(43) Pub. Date: Sep. 28, 2023

(54) LANGUAGE PROCESSING APPARATUS, LEARNING APPARATUS, LANGUAGE PROCESSING METHOD, LEARNING METHOD AND PROGRAM

(71) Applicant: NIPPON TELEGRAPH AND TELEPHONE CORPORATION, Tokyo (JP)

(72) Inventors: Yasuhito OSUGI, Tokyo (JP); Itsumi SAITO, Tokyo (JP); Kyosuke NISHIDA, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/910,717

(22) PCT Filed: Aug. 20, 2020
(86) PCT No.: PCT/JP2020/031522

§ 371 Date: Sep. 9, 2022

(30) Foreign Application Priority Data
Mar. 11, 2020 (WO) PCT/JP2020/010579

(51) Int. Cl. G06F 40/284; G06F 40/30; G06F 40/205; G06N 3/08

(52) U.S. Cl. CPC G06F 40/284; G06F 40/30; G06F 40/205; G06N 3/08

(57) ABSTRACT

A language processing apparatus includes: a preprocessing unit that splits an input text into a plurality of short texts; a language processing unit that calculates a first feature and a second feature using a trained model for each of the plurality of short texts; and an external storage unit configured to store a third feature for one or more short texts, and the language processing unit uses the trained model to calculate the second feature for a certain short text using the first feature of the short text and the third feature stored in the external storage unit.

### TECHNICAL FIELD

The present invention relates to a language understanding model.

### BACKGROUND ART

Research regarding language understanding models has been carried out intensively in recent years. A language understanding model is one type of neural network model for obtaining token distributed representations. According to the language understanding model, it is possible to obtain a distributed representation reflecting semantic relationships with other tokens in a text because the entire text where tokens are used are input to the model instead of inputting a single token into the model.

Examples of the language understanding model described above include a language understanding model disclosed in NPL 1.

### CITATION LIST

### Non Patent Literature

NPL 1: BERT, https://arxiv.org/abs/1810.04805, Internet, retrieved on Feb. 26, 2020

### SUMMARY OF THE INVENTION

### Technical Problem

However, the language understanding model disclosed in NPL 1 has a problem that it is not possible to satisfactorily handle long texts (long token sequence). Note that long texts are texts that are longer than a predetermined length (e.g., 512 tokens that can appropriately be handled by the language understanding model in NPL 1).

The present invention has been made in view of the aforementioned circumstances, and an object thereof is to provide a technique that enables appropriate extraction of features reflecting relationships among tokens in a text even in a case in which a long text is input.

### Means for Solving the Problem

According to the disclosed technique, there is provided a language processing apparatus including: a preprocessing unit configured to split an input text into a plurality of short texts; a language processing unit that calculates a first feature and a second feature for each of the plurality of short texts using a trained model; and an external storage unit configured to store a third feature for one or more short texts, in which the language processing unit calculates the second feature for a certain short text using the first feature of the short text and the third feature stored in the external storage unit, using the trained model.

### Effects of the Invention

According to the disclosed technique, it is possible to appropriately extract features that reflect relationships among tokens in a text even in a case in which a long text is input.

The disclosed technique provides a technique for accurately performing classification of data.

### BRIEF DESCRIPTION OF DRAWINGS

FIG. 1 is a configuration diagram of a language processing apparatus 100 according to a first embodiment.

FIG. 2 is a flowchart illustrating a processing procedure performed by the language processing apparatus 100 according to the first embodiment.

FIG. 3 is a diagram for explaining a configuration and processing of an external storage reading unit 112.

FIG. 4 is a diagram for explaining a configuration and processing of an external storage updating unit 113.

FIG. 5 is a configuration diagram of a language processing apparatus 100 according to a second embodiment.

FIG. 6 is a flowchart illustrating a processing procedure of the language processing apparatus 100 according to the second embodiment.

FIG. 7 is a flowchart illustrating a processing procedure of a language processing apparatus 100 according to a third embodiment.

FIG. 8 is a flowchart illustrating a processing procedure of a language processing apparatus 100 according to a fourth embodiment.

FIG. 9 is a diagram illustrating an example of a hardware configuration of the language processing apparatus 100.

### DESCRIPTION OF EMBODIMENTS

Hereinafter, an embodiment of the present invention (the present embodiment) will be described with reference to the drawings. The embodiments to be described below are examples, and embodiments to which the present invention is applied are not limited to the following embodiments.

Note that a “text” means a sequence of characters and “text” may be referred to as a “sentence” in the present embodiment. Also, a “token” represents a unit of distributed representation such as a word in a text. For example, because words are split into smaller units, that is, sub-words, in NPL 1, a token in NPL 1 is each sub-word.

In the language understanding model disclosed in NPL 1, an attention mechanism and position encoding of a transformer are important elements. The attention mechanism calculates a weight representing how much a certain token is related with other tokens and calculates a distributed representation of the token based on the weight. In the position encoding, a feature representing a position of a certain token in a text is calculated.

However, the language understanding model in the related art disclosed in NPL 1 cannot satisfactorily handle a long text as described above. This is for the following two reasons.

The first reason is that the position encoding learns only a predetermined number of items. The position encoding in NPL 1 learns 512 items and can handle positions of a maximum of 512 tokens in a text. Thus, when a text is longer than 512 tokens, it is not possible to simultaneously handle the 513th and subsequent tokens together with the preceding tokens.

The second reason is that the calculation cost of the attention mechanism is large. In other words, because the attention mechanism calculates scores of relevance of each token with all other tokens in an input text, the cost for calculating the scores increases as a token sequence becomes longer, which disables the calculation using a calculator.

For the aforementioned two reasons, the language understanding model in the related art disclosed in NPL 1 cannot satisfactorily handle a text including a long token sequence. In the present embodiment, the language processing apparatus 100 that solves this problem will be described.

Hereinafter, a configuration and processing of the language processing apparatus 100 including a trained language understanding model to obtain a context feature set from an input text will be described as a first embodiment, and a configuration and processing for training the language understanding model will be described as a second embodiment. Also, examples in which methods different from those in the first and second embodiments are used as an initialization method of an external storage unit 114 and an updating method of the external storage unit 114 will be described as third and fourth embodiments.

### First Embodiment

### Apparatus Configuration Example

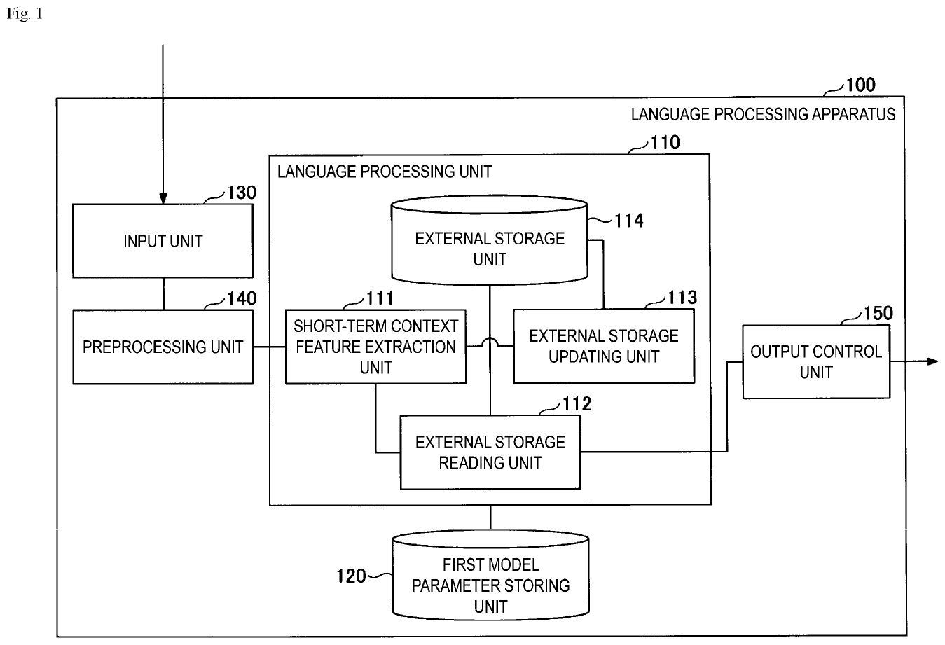

As illustrated in FIG. 1, a language processing apparatus 100 according to the first embodiment includes a language processing unit 110, a first model parameter storing unit 120, an input unit 130, a preprocessing unit 140, and an output control unit 150.

The language processing unit 110 includes a short-term context feature extraction unit 111, an external storage reading unit 112, an external storage updating unit 113, and an external storage unit 114. Although details of the processing performed by the language processing unit 110 will be described later, an outline of each component constituting the language processing unit 110 is as follows. Note that the external storage reading unit 112 may be referred to as a feature calculation unit. Also, the external storage unit 114 included in the language processing apparatus 100 may be provided outside the language processing unit 110.

The short-term context feature extraction unit 111 extracts features from short token sequences obtained by splitting an input text. The external storage reading unit 112 outputs an intermediate feature using information (external storage feature) stored in the external storage unit 114. The external storage updating unit 113 updates information in the external storage unit 114. The external storage unit 114 stores information representing keywords in a long-term context and relationships thereof as information of the long-term context. This information is stored as a feature matrix in the form of a matrix.

Each of the short-term context feature extraction unit 111, an external storage reading unit 112, and the external storage updating unit 113 is implemented as a model of a neural network, for example. The language processing unit 110 that is a functional unit obtained by adding the external storage unit 114 to these three functional units may be referred to as a language understanding model with a memory. The first model parameter storing unit 120 stores learned parameters in the language understanding model with the memory. The learned parameters are set in the language understanding model with the memory, so that the language processing unit 110 can execute operations in the first embodiment.

The input unit 130 receives a long-term text from the outside of the apparatus and passes the long-term text to the preprocessing unit 140. The preprocessing unit 140 transforms the input long-term text into a set of short-term texts and inputs the short-term texts one by one to the short-term context feature extraction unit 111. Note that the long-term text in the first embodiment (and the second to fourth embodiments) may be also referred to as a long text. The long text is a text that is longer than a predetermined length (e.g., 512 tokens that can be appropriately handled by the language understanding model in NPL 1) as described above. Also, the short-term text may be also referred to as a short text. The short text is a text obtained by splitting a text. Note that the text input from the input unit 130 is not limited to a long text and may be a text that is shorter than a long text.

The output control unit 150 receives an intermediate feature of each short-term text from the external storage reading unit 112, receives an intermediate feature of the last short-term text, and then combines the intermediate features, thereby outputting a long-term context feature that is a feature of the input long-term text.

### Operation Example of Apparatus

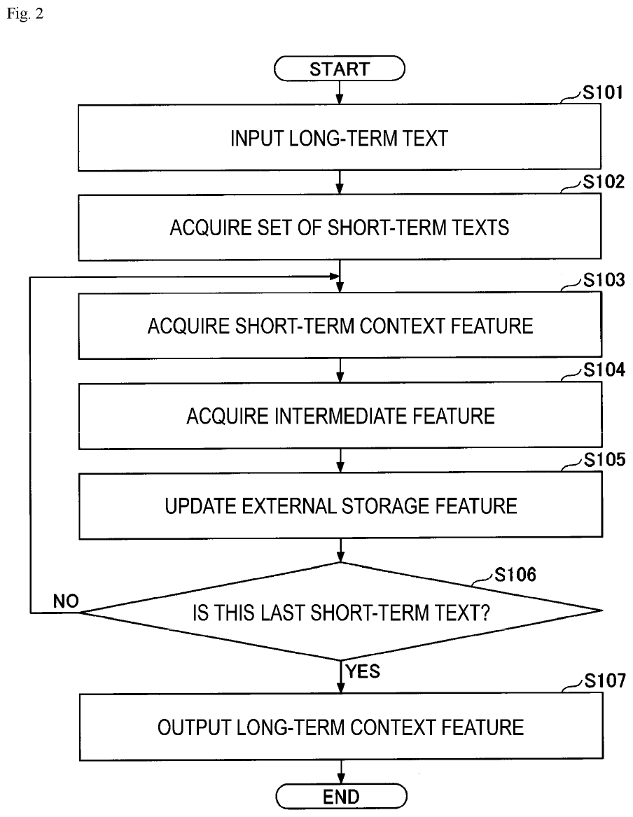

Hereinafter, an operation example of the language processing apparatus 100 in the first embodiment will be described following the order of the flowchart illustrated in FIG. 2. In the first embodiment (the same applies to the second to fourth embodiments), it is assumed that a text has been transformed from a character sequence into a token sequence using an appropriate tokenizer, and the length of the text represents a sequence length of the token sequence (the number of tokens).

S101

In S101, a long-term text is input to the input unit 130. The long-term text is passed from the input unit 130 to the preprocessing unit 140.

S102

In S102, the preprocessing unit 140 splits the input long-term text into one or more short-term texts with a preset length L^{seq}(L^{seq} is an integer that is equal to or greater than one) and obtains a short-term text set S={s₁, s₂, . . . , s_{N}}. For example, if it is assumed that L^{seq} is equal to 32 for a long-term text with a length of 512, N is equal to 16. That is, a short-term text set S including 16 short-term texts is generated.

Processing in S103 to S105 described below is performed on each element (short-term text sᵢ) in the set S.

More specifically, the preprocessing unit 140 splits the long-term text into the short-term texts such that the individual short-term texts including special tokens used for padding and the like have a length L^{seq} in S102.

In a case in which the model disclosed in NPL 1 is used as the short-term context feature extraction unit 111, for example, the long-term text is actually split into one or more token sequences with a length of [L^{seq}−2] because class tokens ([CLS]) or separate tokens ([SEP]), namely two tokens, are added at the beginning and end of each token sequence.

S103

In S103, the short-term text sᵢ is input to the short-term context feature extraction unit 111, and the short-term context feature extraction unit 111 calculates a short-term context feature hᵢ∈R^{d×Lseq} for the short-term text sᵢ. Note that the upper right superscript “d×L^{seq}” of R^{d×Lseq} (a real matrix set of d×L^{seq}) is described as “d×Lseq” for convenience of description. Here, d represents the number of dimensions of the feature. For example, d is equal to 768.

The short-term context feature extraction unit 111 calculates the short-term context feature in consideration of relationships between each token and all the other tokens in sᵢ. The short-term context feature extraction unit 111 can use the neural network model (BERT) disclosed in NPL 1 as the short-term context feature extraction unit 111, for example, although the model is not limited to a specific one. In the first embodiment (and the second to fourth embodiments), BERT is used as the short-term context feature extraction unit 111.

BERT can take the relationships between each token and the other tokens into consideration using the attention mechanism and output a feature reflecting the relationships for each token. As disclosed in a reference document (Transformer (https://arxiv.org/abs/1706.03762)), the attention mechanism is represented by Equation (1) below. Note that, in Equation (1) below, dₖ in the aforementioned reference document is described as d.

$$\begin{matrix}[ Math . 1 ] & \\ Attention ( Q , K , V ) = softmax ( \frac{Q {K}^{T}}{\sqrt{d}} ) V & ( 1 )\end{matrix}$$

The short-term context feature extraction unit 111 creates Q, K, and V from the feature of sᵢ and calculates attention by Equation (1) described above. In Equation (1), Q is an abbreviation of Query, K is an abbreviation of Key, and V is an abbreviation of Value. In a case in which the short-term context feature extraction unit 111 (that is, BERT) takes the relationships between each token and the other tokens into consideration, each of Q, K, and V in Equation (1) described above represents a matrix obtained by linearly transforming the feature of each token, and the relationship Q, K, V∈R^{d×Lseq} is satisfied. Note that, although the number of feature dimensions of Q, K, and V obtained through the linear transform is assumed to be the same as the number d of feature dimensions of hᵢ in the present embodiment, the number of feature dimensions of Q, K, and V may be different from the number d of feature dimensions of hᵢ.

In Equation (1) described above, calculation of the following softmax function represents that a score (probability) representing how much a token is related with another token is calculated based on an inner product (QKT) between features of the tokens.

$$softmax ( \frac{Q {K}^{T}}{\sqrt{d}} ) \qquad [ Math . 2 ]$$

A weighted sum of V with the score is an output of attention, that is, a feature representing how much another token is related to the token. The short-term context feature extraction unit 111 obtains the feature reflecting the relevance between the token and another token by adding Attention (Q, K, V) and the feature of the token.

S104

In S104, the short-term context feature hᵢ obtained in S103 and the external storage feature m∈R^{d×M} stored in the external storage unit 114 are input to the external storage reading unit 112, and the external storage reading unit 112 calculates an intermediate feature vᵢ∈R^{d×Lseq} from the input information and outputs the intermediate feature. Although the numbers of feature dimensions of vᵢ and m are d and the same in the present embodiment, the numbers of feature dimensions may be different from each other.

M in m∈R^{d×M} represents the number of slots of the external storage feature. The external storage feature is a vector obtained by extracting necessary information from {sᵢ, . . . , sᵢ₋₁} and storing the information. The way in which the information is extracted and stored as a vector will be described in S105 (updating processing). Note that the external storage feature m is appropriately initialized in advance, and for example, the external storage feature m is initialized with a random numerical value prior to the processing related to sᵢ. Such an initialization method is just an example, and a method for the initialization in the third embodiment (and the fourth embodiment) is different from the initialization method using a random numerical value.

The external storage reading unit 112 compares the elements of the short-term context feature hᵢ and the external storage feature m, extracts necessary information from the external storage feature, and adds the extracted information to information included in hᵢ. It is thus possible to obtain an intermediate feature related to sᵢ reflecting the information of {sᵢ, . . . , sᵢ₋₁}.

In other words, the external storage reading unit 112 performs matching between two features (between hᵢ and m) and extracts necessary information. The neural network model executing the processing is not limited to a specific model, and a model using the attention mechanism of the aforementioned reference document (Equation (1) can be used, for example. In the present embodiment, a model using the attention mechanism is used.

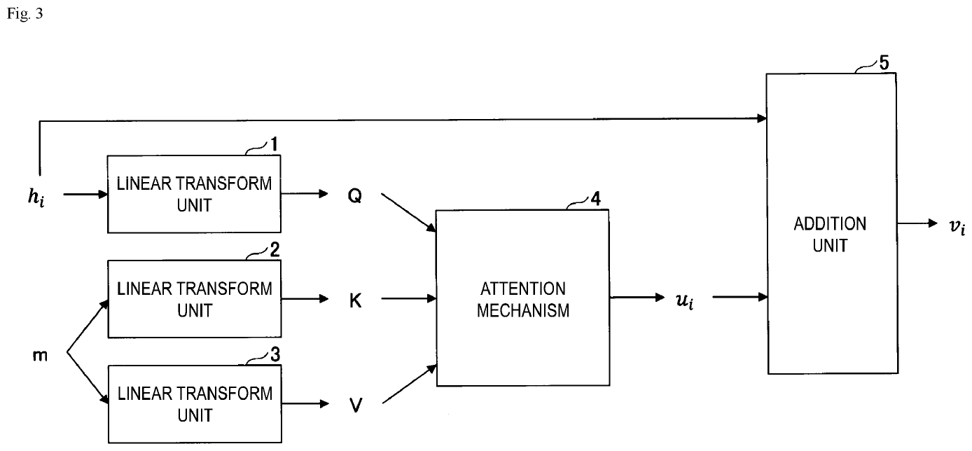

FIG. 3 is a diagram illustrating a configuration (and processing details) of a model corresponding to the external storage reading unit 112.

As illustrated in FIG. 3, the model includes a linear transform unit 1, a linear transform unit 2, a linear transform unit 3, an attention mechanism 4 (Equation (1)), and an addition unit 5. The linear transform unit 1 performs a linear transform on the short-term context feature hᵢ to output Q, and the linear transform units 2 and 3 perform a linear transform on m and output K and V, respectively.

Q, K, and V are input to the attention mechanism 4 (Equation (1)), and the attention mechanism 4 (Equation (1)) outputs uᵢ=Attention (Q, K, V).

Q (Query) is obtained based on hᵢ, and K (Key) and V (Value) are obtained based on m as described above.

Thus, the following softmax function corresponds to a probability representing how much each token in the short text (short-term text) is related to each slot of the external storage feature, and the external storage feature is weighted with the probability and summed up. This corresponds to each vector of uᵢ.

$$softmax ( \frac{Q {K}^{T}}{\sqrt{d}} ) \qquad [ Math . 3 ]$$

In other words, uᵢ stores information of the external storage feature related to each token in the short text. As illustrated in FIG. 3, the addition unit 5 can obtain the intermediate feature vᵢ reflecting information of the long-term context in the external storage feature by adding uᵢ and hᵢ.

S105

In S105, the short-term context feature hᵢ obtained in S103 and the external storage feature m are input to the external storage updating unit 113, and the external storage updating unit 113 calculates a new external storage feature m\hat{ } based on these inputs, outputs the new external storage feature m\hat{ } to the external storage unit 114, and updates m with m\hat{ }. Note that the hat (\hat{ }) above m is notated after m as in “m\hat{ }” in the specification for convenience of description.

The external storage updating unit 113 compares elements of the short-term context feature hᵢ and the external storage feature m, extracts information to be saved in the information of hᵢ, and overwrites m, thereby updating information.

In other words, the external storage updating unit 113 performs matching between two features (between hᵢ and m) and extracts necessary information. The neural network model executing the processing is not limited to a specific model, and the attention mechanism of the aforementioned reference document (the model using Equation (1)) can be used, for example. In the present embodiment, a model using the attention mechanism is used.

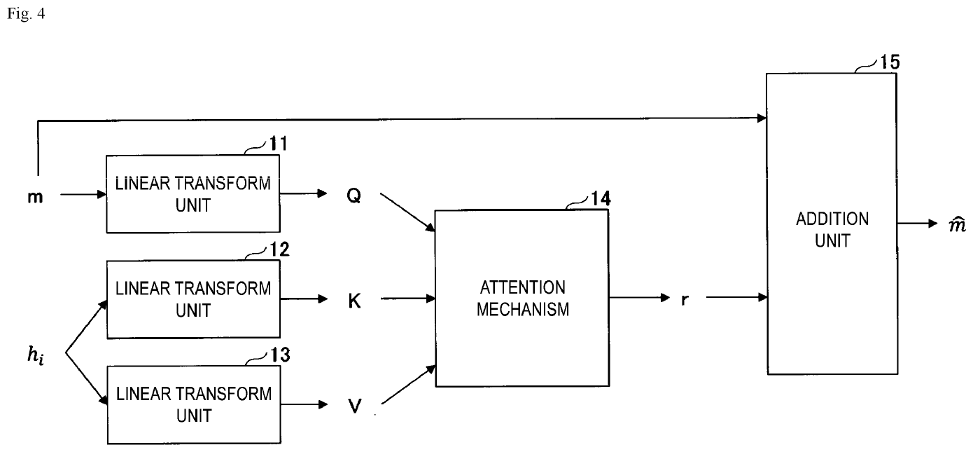

FIG. 4 is a diagram illustrating a configuration (and processing details) of a model corresponding to the external storage updating unit 113.

As illustrated in FIG. 4, the model includes a linear transform unit 11, a linear transform unit 12, a linear transform unit 13, an attention mechanism 14 (Equation (1)), and an addition unit 15. The linear transform unit 11 performs a linear transform on m to output Q, and the linear transform units 12 and 13 perform a linear transform on the short-term context feature hᵢ to output K and V, respectively.

Q, K, and V are input to the attention mechanism 14 (Equation (1)), and the attention mechanism 14 (Equation (1)) obtains r=Attention (Q, K, V).

Q is obtained based on m and K and V are obtained based on hᵢ as described above.

Thus, the following softmax function corresponds to a probability representing how much each slot of the external storage feature is related to each token of the short-term text, and the feature of the token of the short-term text is weighted with the probability and summed up. This corresponds to each vector of r.

$$softmax ( \frac{Q {K}^{T}}{\sqrt{d}} ) \qquad [ Math . 4 ]$$

In other words, r stores information regarding the tokens in the short-term text related to each slot of the external storage feature. As illustrated in FIG. 4, the addition unit 15 adds r and m. In this manner, necessary information r is extracted from sᵢ and is added to information m that has been extracted until now, and thereby the feature m\hat{ } is obtained. In other words, it is possible to obtain the new external storage feature m\hat{ } by extracting and storing necessary information from {s₁, . . . , sᵢ}.

Note that the method of updating m as described above is just an example, and m is updated by a method that is different from the aforementioned updating method in the third embodiment (and the fourth embodiment).

S106 and S107

In S106, the output control unit 150 determines whether or not the intermediate feature vᵢ received from the external storage reading unit 112 is an intermediate feature for the last short-term text, and if the intermediate feature vᵢ is not the intermediate feature for the last short-term text, the output control unit 150 performs control to perform the processing from S103 on the next short-term text.

In a case in which the intermediate feature vᵢ is an intermediate feature for the last short-term text, that is, S103 to S105 are performed on all S={s₁, s₂, . . . , s_{N}}, the output control unit 150 obtains a long-term context feature V by combining each vᵢ in the set {v₁, . . . , v_{N}} of the obtained intermediate features in the sequence length direction, and outputs the obtained long-term context feature V.

If S103 to S107 are executed on the assumption of L^{seq}=32 for a long-term text with the length of 512, for example, {v₁, . . . , v₁₆} is obtained. If it is assumed that d=768, vᵢ is a matrix of 768×32 in which 32 column vectors of 768 dimensions are aligned. A matrix of 768×512 obtained by combining this in the column direction is defined as a long-term context feature V for the input long-term text.

### Second Embodiment

Next, the second embodiment will be described. In the second embodiment, a configuration and processing details of a language processing unit 110, that is, a language understanding model with a memory for learning model parameters, will be described.

Although the method of training the language understanding model with the memory is not limited to a specific method, a method of learning model parameters through a task (e.g., Section 3.1 Task #1 Masked LM in NPL 1) for predicting masked tokens will be described as an example in the present embodiment.

Apparatus Configuration Example

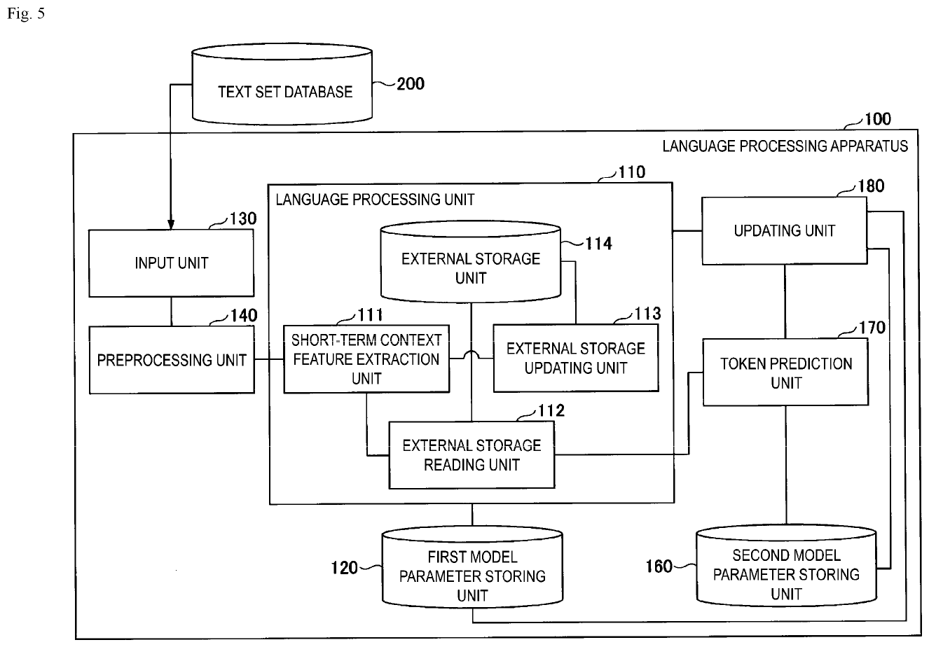

As illustrated in FIG. 5, the language processing apparatus 100 according to the second embodiment includes a language processing unit 110, a first model parameter storing unit 120, an input unit 130, a preprocessing unit 140, a second model parameter storing unit 160, a token prediction unit 170, and an updating unit 180. The language processing unit 110 includes a short-term context feature extraction unit 111, an external storage reading unit 112, an external storage updating unit 113, and an external storage unit 114. The external storage unit 114 included in the language processing apparatus 100 may be provided outside the language processing unit 110.

In other words, the language processing apparatus 100 according to the second embodiment is configured by excluding the output control unit 150 and adding the second model parameter storing unit 160, the token prediction unit 170, and the updating unit 180 as compared with the language processing apparatus 100 according to the first embodiment. The configurations and the operations other than those of the added components are basically the same as those in the first embodiment.

Note that it is possible to perform learning of model parameters and acquisition of a long-term context feature described in the first embodiment by a single language processing apparatus 100 by using the language processing apparatus 100 obtained by adding the second model parameter storing unit 160, the token prediction unit 170, and the updating unit 180 to the language processing apparatus 100 according to the first embodiment. Also, the language processing apparatus 100 according to the second embodiment and the language processing apparatus 100 according to the first embodiment may be separate apparatuses. In that case, model parameters obtained through learning processing performed by the language processing apparatus 100 according to the second embodiment are stored in the first model parameter storing unit 120 of the language processing apparatus 100 according to the first embodiment, so that the language processing apparatus 100 according to the first embodiment can acquire a long-term context feature. Also, the language processing apparatus 100 according to the second embodiment may be referred to as a learning apparatus.

The token prediction unit 170 uses vᵢ to predict tokens. The token prediction unit 170 according to the second embodiment is implemented as a model of a neural network. The updating unit 180 updates model parameters of the short-term context feature extraction unit 111, the external storage reading unit 112, and the external storage updating unit 113 and a model parameter of the token prediction unit 170 based on correct solutions of tokens and token prediction results. The model parameter of the token prediction unit 170 is stored in the second model parameter storing unit 160.

Also, long texts released on the Web are collected and stored in a text set database 200 illustrated in FIG. 5 in the second embodiment. A long-term text is read from the text set database 200. For example, writings in one paragraph (which may also be referred to as sentences) in a certain document may be handled as one long-term text.

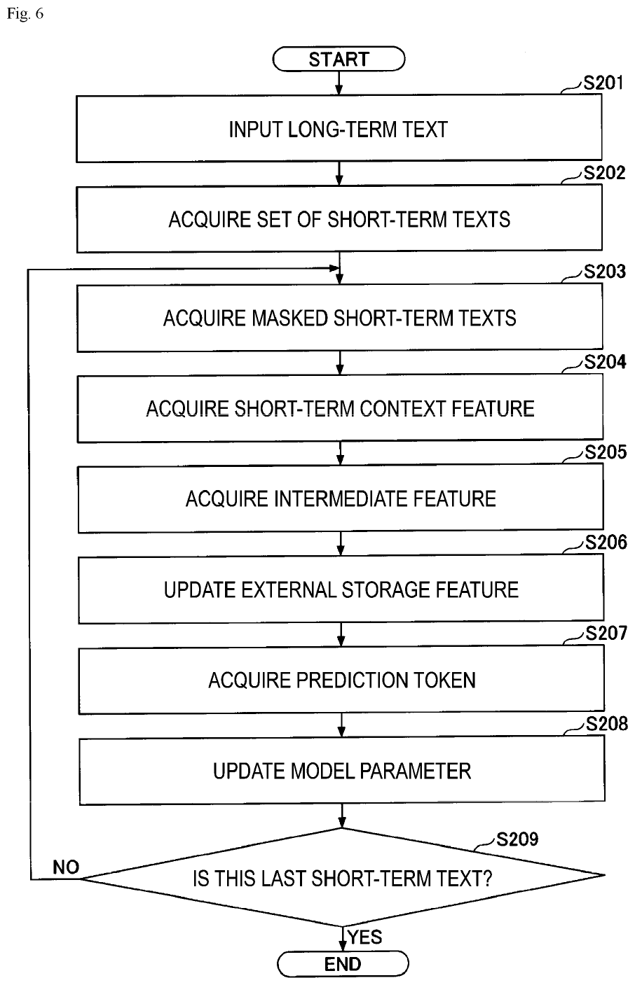

Operation Example of Apparatus Hereinafter, an operation example of the language processing apparatus 100 according to the second embodiment will be described following the order of the flowchart illustrated in FIG. 6. It is assumed that the model parameters of the short-term context feature extraction unit 111, the external storage reading unit 112, and the external storage updating unit 113 and the model parameter of the token prediction unit 170 have been initialized with any appropriate values.

S201

In S201, a long-term text is read from the text set database and input to the input unit 130. The long-term text is passed from the input unit 130 to the preprocessing unit 140.

S202

In S102, the preprocessing unit 140 splits the input long-term text into one or more short-term texts with a preset length L^{seq} (L^{seq} is an integer that is equal to or greater than one) and obtains a short-term text set S={s₁, s₂, . . . , s_{N}}.

The following processing is performed on each element (short-term text sᵢ) in the set S obtained in S202.

S203

The preprocessing unit 140 selects some tokens among tokens in sᵢ and replaces the selected tokens with mask tokens ([MASK]) or other randomly selected tokens or maintains the selected tokens as they are to obtain masked short-term text sᵢ\hat{ }. Here, conditions for the replacement and the maintaining may be the same as those in NPL 1. At this time, the tokens selected as targets of the replacement or the maintaining are prediction targets of the token prediction unit 170.

S204, S205, and S206

An intermediate feature vᵢ for the short-term text sᵢ\hat{ } is obtained through the same processing as that in S103, S104, and S105 in the first embodiment, and the external storage feature m is updated.

S207 The external storage reading unit 112 inputs the intermediate feature vᵢ to the token prediction unit 170, and the token prediction unit 170 outputs the prediction token.

In the second embodiment, the token prediction unit 170 is a mechanism for predicting a t-th token from predetermined vocabulary based on a feature vᵢ^{(t)}∈R^{d} related to the t-th token of vᵢ. The t-th token corresponds to the token that is a target of the replacement or the maintaining. The mechanism enables prediction of the token from the vocabulary by converting vᵢ^{(t)} into a feature y^{(t)}∈R^{d′} with the number of dimensions being a vocabulary size d′ and using an index that maximizes the value of the element of y^{(t)} using a one-layer feed forward network, for example.

For example, it is assumed that d′=32000 and prediction is performed in regard to which vocabulary in a set (list) of 32000 words the t-th token is. In a case in which 3000-th element has a maximum value among elements of y^{(t)} that is a vector of 32000 dimensions, the 3000-th token in the vocabulary list is the token to be obtained.

S208

In S208, the masked short-term text and the prediction token are input to the updating unit 180, and the updating unit 180 updates a model parameter in the first model parameter storing unit 120 and a model parameter in the second model parameter storing unit 160 through supervised learning.

S209

In S209, the token prediction unit 170 determines whether or not the intermediate feature vᵢ received from the external storage reading unit 112 is an intermediate feature for the last short-term text, and if the intermediate feature vᵢ is not the intermediate feature for the last short-term text, control is performed such that the processing from S203 is performed on the next short-term text.

In a case in which the intermediate feature vᵢ is the intermediate feature for the last short-term text, that is, S203 to S208 have been performed on all S={s₁, s₂, . . . , s_{N}}, the processing is ended.

### Third Embodiment

In the first embodiment for obtaining a context feature set from an input text, the external storage unit 114 is initialized by inputting a random value. Also, in the first embodiment, the new external storage feature m\hat{ } is calculated by performing matching between the short-term context feature hᵢ and the external storage feature m and extracting necessary information, and m is updated to m\hat{ }, using the configuration illustrated in FIG. 4.

In the third embodiment, a processing method in which methods of initializing and updating the external storage unit 114 are different from those in the first embodiment will be described. Hereinafter, a difference from the first embodiment will be mainly described.

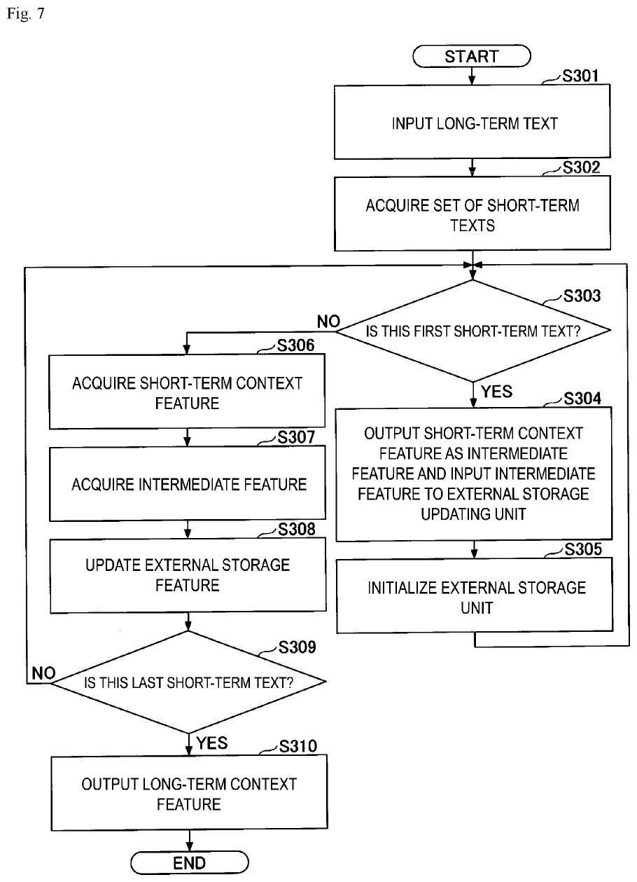

The apparatus configuration of the language processing apparatus 100 according to the third embodiment is the same as the apparatus configuration of the language processing apparatus 100 according to the first embodiment as illustrated in FIG. 1. Hereinafter, an operation example of the language processing apparatus 100 according to the first embodiment will be described following the order of the flowchart illustrated in FIG. 7.

S301 and S302 S301 and S302 are the same as S101 and S102 in the first embodiment.

S303

In S303, the short-term context feature extraction unit 111 receives one short-term text from the preprocessing unit 140 and determines whether or not the short-term text is the first short-term text. The processing proceeds to S306 if the short-term text is not the first short-term text, or the processing proceeds to S304 if the short-term text is the first short-term text.

S304

In S304 performed in the case in which the short-term text sᵢ received from the preprocessing unit 140 is the first short-term text, the short-term context feature extraction unit 111 calculates a short-term context feature hᵢ∈R^{d×Lseq} for the short-term text sᵢ and outputs the short-term context feature hᵢ as an intermediate feature vᵢ∈R^{d×Lseq} In other words, it is assumed that vᵢ=hᵢ for the first short-term text sᵢ. The output intermediate feature hᵢ is input to the external storage updating unit 113.

S305

In S305, the external storage updating unit 113 initializes the external storage feature m stored in the external storage unit 114 using vᵢ (=hᵢ). Specifically, m⁽²⁾∈R^{d} that is a d-dimensional vector is created by performing a predetermined operation on hᵢ, and m⁽²⁾ is stored as an initial value of the external storage feature in the external storage unit 114.

hᵢ is a matrix of d×L^{seq}. The aforementioned predetermined operation may be an operation for obtaining an average of values of elements for each dimension of d, that is, for each row (a vector of the number of elements L^{seq}), may be an operation for extracting a maximum value among the values of L^{seq} elements, or may be other operations, for example. Note that the reason that the index of m starts from 2 like m⁽²⁾ is because the external storage feature is used from the processing on the second short-term text.

It is possible to initialize the external storage feature with a more appropriate value by using the initialization method in the third embodiment.

S306 and S307

The processing in S306 performed in a case in which the short-term text sᵢ received from the preprocessing unit 140 is not the first short-term text and the next processing in S307 are the same as S103 and S104 in the first embodiment. However, as the external storage feature m in the calculation of the intermediate feature vᵢ in S307, the external storage feature m⁽²⁾ initialized in S305 is used for the second short-term text, and the external storage feature m⁽ⁱ⁾ updated in S308 for previous short-term texts is used for the subsequent short-term texts.

S308

In S308, the short-term context feature hᵢ obtained in S306 and the external storage feature m⁽ⁱ⁾ are input to the external storage updating unit 113, and the external storage updating unit 113 calculates a new external storage feature m⁽ⁱ⁺¹⁾ based on these inputs, outputs the new external storage feature m⁽ⁱ⁺¹⁾ to the external storage unit 114, and updates m⁽ⁱ⁾ with m⁽ⁱ⁺¹⁾.

More specifically, the external storage updating unit 113 creates a vector α with d dimensions from hᵢ by executing the same operation as the initialization operation in S305 on hᵢ. Next, the external storage updating unit 113 creates m⁽ⁱ⁺¹⁾ that is a new external storage feature using m⁽ⁱ⁾ and α before updating as follows.

m⁽ⁱ⁺¹⁾=[m⁽ⁱ⁾,α]

[,] in the above equation represents that a vector or a matrix is added in the column direction. In other words, m⁽ⁱ⁺¹⁾ is obtained by adding a to m⁽ⁱ⁾. In other words, m⁽ⁱ⁾∈R^{d×(i-1)} (i≥2).

It is possible to store more explicit information as the external storage feature in the external storage unit 114 by using the updating method in the third embodiment.

### Fourth Embodiment

Next, the fourth embodiment will be described. The fourth embodiment is an embodiment for training the language understanding model used in the third embodiment. Hereinafter, a difference from the second embodiment will be described.

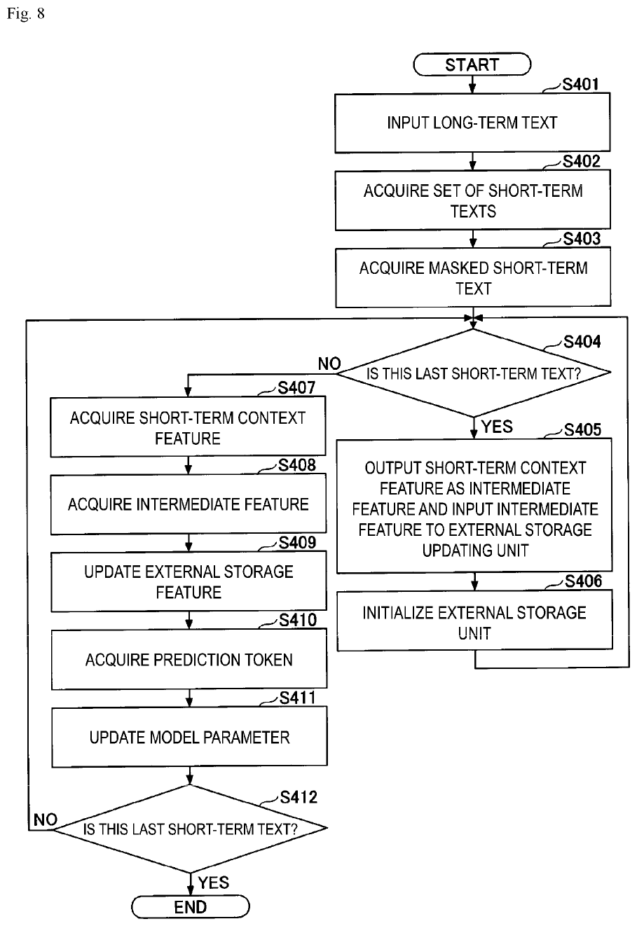

The apparatus configuration of a language processing apparatus 100 according to the fourth embodiment is the same as the apparatus configuration of the language processing apparatus 100 according to the second embodiment as illustrated in FIG. 5. Hereinafter, an operation example of the language processing apparatus 100 according to the fourth embodiment will be described following the order of the flowchart illustrated in FIG. 8.

S401 to S403

S401 to S403 are the same as S201 to S203 in the second embodiment.

S404 to S409

In S404 to S409, the external storage feature is initialized, the intermediate feature vᵢ for the short-term text sᵢ is obtained, the external storage feature m⁽ⁱ⁾ is updated, and the external storage feature m⁽ⁱ⁺¹⁾ is obtained through the same processing as that in S303 to S308 in the third embodiment.

S410 to S412

S410 to S412 are the same as S207 to S209 in the second embodiment.

Hardware Configuration Example

The language processing apparatus 100 in the present embodiment can be achieved by causing a computer, for example, to execute a program describing content of the processing described in the present embodiment. Further, the “computer” may be a physical machine or a virtual machine on cloud. In a case where a virtual machine is used, “hardware” to be described here is virtual hardware.

The above program can be stored or distributed with the program recorded on a computer readable recording medium (such as a portable memory). In addition, the above program can also be provided through a network such as the Internet or e-mail.

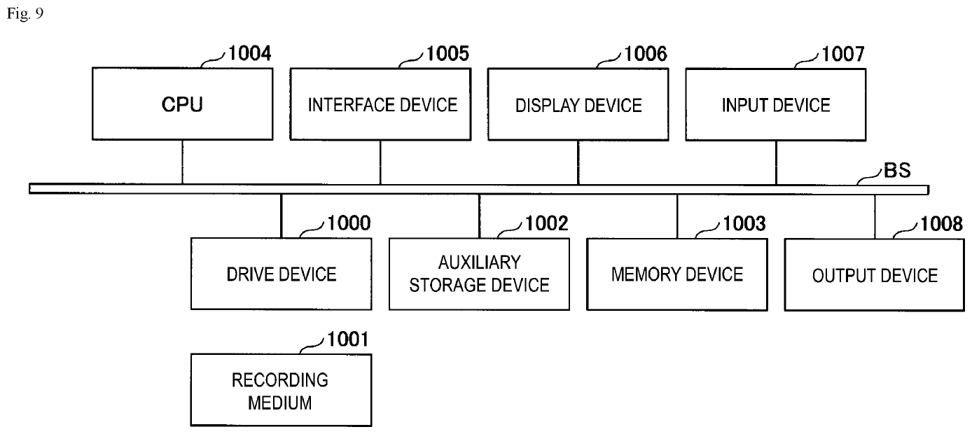

FIG. 9 is a diagram illustrating a hardware configuration example of the aforementioned computer. The computer in FIG. 9 includes a drive device 1000, an auxiliary storage device 1002, a memory device 1003, a CPU 1004, an interface device 1005, a display device 1006, an input device 1007, and the like which are connected to each other through a bus BS. Note that the computer may include a graphics processing unit (GPU) instead of or in addition to the CPU 1004.

A program for implementing processing in the computer is provided by means of a recording medium 1001 such as a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 (or a GPU or the CPU 1004 and the GPU) implements the functions related to the apparatus in accordance with the program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, and the like, and is used for inputting various operation instructions.

### Effects of Embodiments

As described above, because information of short-term texts obtained by splitting a long-term text is sequentially written in the external storage unit 114, and information regarding texts (information regarding long contexts) stored in the external storage unit 114 and written until now is used when a feature of a new short-term text is calculated in the present embodiment, it is possible to consistently handle a long text.

In other words, it is possible to curb calculation cost in the attention mechanism by dividing processing for short-term information and processing for long-term information in the present embodiment. Also, it is possible to store long-term information in the external storage unit 114 and thereby to handle a long text without limitation of a sequence length.

### Conclusion of Embodiments

At least the language processing apparatus, the learning apparatus, the language processing method, the learning method, and the program described in the following clauses are described in the specification.

### Clause 1

A language processing apparatus including:
a preprocessing unit configured to split an input text into a plurality of short texts;
a language processing unit configured to calculate a first feature and a second feature for each of the plurality of short texts using a trained model; and
an external storage unit configured to store a third feature for one or more short texts, in which the language processing unit uses the trained model to calculate the second feature for a certain short text using the first feature of the short text and the third feature stored in the external storage unit.

### Clause 2

The language processing apparatus according to Clause 1, in which
every time the second feature of the short text is calculated, the language processing unit uses the trained model to update the third feature stored in the external storage unit using a feature for the short text, the feature reflecting a relationship between each token in the short text and information stored in the external storage unit.

### Clause 3

The language processing apparatus according to Clause 1, in which
the language processing unit initializes the third feature stored in the external storage unit through execution of a predetermined operation on the first feature calculated using the trained model.

### Clause 4

The language processing apparatus according to Clause 1 or 3, in which
every time the second feature of the second or subsequent short text is calculated, the language processing unit uses the trained model to create a fourth feature through execution of a predetermined operation on the first feature for the second or subsequent short text and creates an updated third feature by adding the fourth feature to the third feature before updating.

### Clause 5

A learning apparatus including:
a preprocessing unit configured to transform some of all tokens included in a certain short text among a plurality of short texts obtained by splitting an input text into other tokens or maintain some of all the tokens without transformation;
a language processing unit configured to calculate a first feature and a second feature for the short text with the some tokens transformed or maintained using a model;
an external storage unit configured to store a third feature for one or more of the short texts with the some tokens transformed or maintained;
a token prediction unit configured to predict the some tokens using the second feature; and
an updating unit configured to update a model parameter of the model constituting the language processing unit based on the some tokens and a prediction result obtained by the token prediction unit, in which
the language processing unit uses the model to
calculate the second feature for the short text with the some tokens transformed or maintained using the first feature of the short text and the third feature stored in the external storage unit, and execute processing of the preprocessing unit, the language processing unit, the token prediction unit, and the updating unit on each of the plurality of short texts.

### Clause 6

A language processing method executed by a language processing apparatus, the method including:
splitting an input text into a plurality of short texts; and
performing language processing of calculating a first feature and a second feature for each of the plurality of short texts using a trained model, in which
the language processing apparatus includes an external storage unit configured to store a third feature for one or more short texts, and
in the performing of the language processing, the trained model is used to calculate the second feature of a certain short text using the first feature of the short text and the third feature stored in the external storage unit.

### Clause 7

A learning method executed by a learning apparatus including a model, the method including:
performing preprocessing of transforming some of all tokens included in a certain text among a plurality of short texts obtained by splitting an input text into other tokens or maintaining some of all the tokens without transformation;
performing language processing of calculating a first feature and a second feature for the short text with the some tokens transformed or maintained using the model;
predicting the some tokens using the second feature; and
updating a model parameter of the model based on the some tokens and a prediction result obtained in the predicting, in which
the learning apparatus includes an external storage unit configured to store a third feature for one or more of the short texts with the some tokens transformed or maintained, and
in the performing of the language processing, the model is used to calculate the second feature of the short text with the some tokens transformed or maintained using the first feature of the short text and the third feature stored in the external storage unit, and
the processing in the performing of the preprocessing, the performing of the language processing, the predicting, and the updating is executed on each of the plurality of short texts.

### Clause 8

A program for causing a computer to operate as each unit of the language processing apparatus according to any one of clauses 1 to 4.

### Clause 9

A program for causing a computer to operate as each unit of the learning apparatus according to clause 5.

Although the present embodiment has been described above, the present invention is not limited to such specific embodiments, and can be modified and changed variously without departing from the scope of the present invention described in the appended claims.

### REFERENCE SIGNS LIST

100 Language processing apparatus
110 Language processing unit
111 Short-term context feature extraction unit
112 External storage reading unit
113 External storage updating unit
114 External storage unit
120 First model parameter storing unit
130 Input unit
140 Preprocessing unit
150 Output control unit
160 Second model parameter storing unit
170 Token prediction unit
180 Updating unit
200 Text set database
1000 Drive device
1001 Recording medium
1002 Auxiliary storage device
1003 Memory device
1004 CPU
1005 Interface device
1006 Display device
1007 Input device

1. A language processing apparatus comprising a processor configured to execute a method comprising:
preprocessing including splitting a input text into a plurality of short texts;
calculating a first feature and a second feature associated with a short text of the plurality of short texts using a trained model; and
storing a third feature for one or more short texts of the plurality of short texts; and
wherein calculating the second feature for the short text is based on using the first feature of the short text and the third feature using the trained model.

2. The language processing apparatus according to claim 1, wherein
when calculating the second feature associated with the short text, updating the third feature based on a fourth feature for the short text using the trained model, the fourth feature reflecting a relationship between each token in the short text and the third feature for the one or more short texts.

3. The language processing apparatus according to claim 1, the processor further configures to execute a method comprising:
initializing the third feature by executing a predetermined operation on the first feature calculated using the trained model.

4. The language processing apparatus according to claim 1, the processor further configured to execute a method comprising:
when the second feature of the second text is calculated, creating a fourth feature through execution of a predetermined operation on the first feature for the second short text using the trained model, and creating an updated third feature by adding the fourth feature to the third feature before updating using the trained model.

5. A learning apparatus comprising a processor configured to execute a method comprising:
transforming a token included in a short text among a plurality of short texts obtained by splitting an input text into other tokens;
calculating a first feature and a second feature for the short text with the token transformed using a model;
storing a third feature for one or more of the short texts with the tokens transformed;
predicting the token using the second feature; and
updating a model parameter of the model based on the token and the predicted token;
calculating the second feature for the short text with the some tokens transformed based on the first feature of the short text and the third feature using the trained model.

6. A computer implemented method for processing a language, the method comprising:
splitting an input text into a plurality of short texts; and
determining a combination of a first feature and a second feature for a short text of the plurality of short texts using a trained model;
storing a third feature associated with one or more short texts, wherein
calculating the second feature of a short text based on the first feature of the short text and the third feature using the trained model.

7-9. (canceled)

10. The language processing apparatus according to claim 1, wherein the model includes a neural network.

11. The language processing apparatus according to claim 1, wherein the short text corresponds to less than 512 tokens.

12. The language processing apparatus according to claim 1, wherein the input text includes more than 512 words.

13. The language processing apparatus according to claim 1, wherein the first feature corresponds to a trained parameter associated with a language understanding model with a memory.

14. The language processing apparatus according to claim 1, wherein the third feature includes information represents a plurality of keywords in a long-term context and relationships among the plurality of keywords.

15. The language processing apparatus according to claim 2, the processor further configured to execute a method comprising:
when the second feature of the second or subsequent short text is calculated, creating a fourth feature through execution of a predetermined operation on the first feature for the second short text using the trained model, and creating an updated third feature by adding the fourth feature to the third feature before updating using the trained model.

16. The language processing apparatus according to claim 3, the processor further configured to execute a method comprising:
when the second feature of the second or subsequent short text is calculated, creating a fourth feature through execution of a predetermined operation on the first feature for the second short text using the trained model, and creating an updated third feature by adding the fourth feature to the third feature before updating using the trained model.

17. The learning apparatus according to claim 5, wherein,
when calculating the second feature associated with the short text, updating the third feature based on a feature for the short text using the trained model, the feature reflecting a relationship between each token in the short text and the third feature for the one or more short texts.

18. The learning apparatus according to claim 5, the processor further configured to execute a method comprising:
when the second feature of the second or subsequent short text is calculated, creating a fourth feature through execution of a predetermined operation on the first feature for the second short text using the trained model, and creating an updated third feature by adding the fourth feature to the third feature before updating using the trained model.

19. The learning apparatus according to claim 5, wherein the first feature corresponds to a trained parameter associated with a language understanding model with a memory.

20. The learning apparatus according to claim 5, wherein the third feature includes information represents a plurality of keywords in a long-term context and relationships among the plurality of keywords.

21. The computer implemented method according to claim 6, when calculating the second feature associated with the short text, updating the third feature based on a feature for the short text using the trained model, the feature reflecting a relationship between each token in the short text and the third feature for the one or more short texts.

22. The computer implemented method according to claim 6, the method further comprising:
when the second feature of the second or subsequent short text is calculated, creating a fourth feature through execution of a predetermined operation on the first feature for the second short text using the trained model, and creating an updated third feature by adding the fourth feature to the third feature before updating using the trained model.

23. The computer implemented method according to claim 6, wherein the first feature corresponds to a trained parameter associated with a language understanding model with a memory, and the third feature includes information represents a plurality of keywords in a long-term context and relationships among the plurality of keywords.
